(19) United States
(12) Patent Application Publication
(10) Pub. No.: US 2013/0075030 A1
(43) Pub. Date: Mar. 28, 2013

(54) LIQUID DISPENSER AND APPLICATION METHOD THEREOF

(71) Applicant: CHIEN-CHUN WANG, Tu-Cheng (TW)

(72) Inventor: CHIEN-CHUN WANG, Tu-Cheng (TW)

(73) Assignee: HON HAI PRECISION INDUSTRY CO., LTD., Tu-Cheng (TW)

(21) Appl. No.: 13/300,668

(22) Filed: Nov. 21, 2011

(30) Foreign Application Priority Data
Sep. 27, 2011 (TW) 100134738

(51) Int. Cl. B32B 37/12; B32B 37/14; B05C 5/02

(52) U.S. Cl. 156/272.4; 118/300

(57) ABSTRACT

A liquid dispenser is used for a lens module. The lens module includes a lens barrel and a component received in the lens barrel. The liquid dispenser includes a magnetic support base and a needle. The magnetic support base defines at least one hole for receiving the lens module. The needle contains a magnetic glue. The needle dispenses the magnetic glue on the component, and the magnetic support base attracts the magnetic glue to flow towards an inner surface of the lens barrel by magnetic force.

### BACKGROUND

1. Technical Field

The present invention relates generally to liquid dispensers for glue, adhesive, or the like.

2. Description of Related Art

Lens modules are widely employed in camera systems and mobile phones for image capturing. Generally, a lens module includes a lens barrel, a lens group, a spacer, and a filter (e.g., an IR-cut filter). The lens group, the spacer and the filter are received in the lens barrel and arranged along an optical axis of the lens group, in that order, from the object side to the image side of the lens module. In assembly, the last components mounted into the lens barrel, which may be a lens or the spacer, is bonded to the lens barrel via a glue/adhesive dispensed by a liquid dispenser. Yet, if the glue dispensed on the lens or the spacer is too much, the glue will flow to the optical portion of the lens and make the whole lens module useless.

What is needed, therefore, is a liquid dispenser and a dispensing method which could overcome the limitations described above.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a liquid dispenser according to an embodiment, showing the liquid dispenser used to dispense glue to lens modules.

FIG. 2 is an isometric, enlarged view of the lens module of FIG. 1.

FIG. 3 is a sectional view along line of FIG. 2.

### DETAILED DESCRIPTION

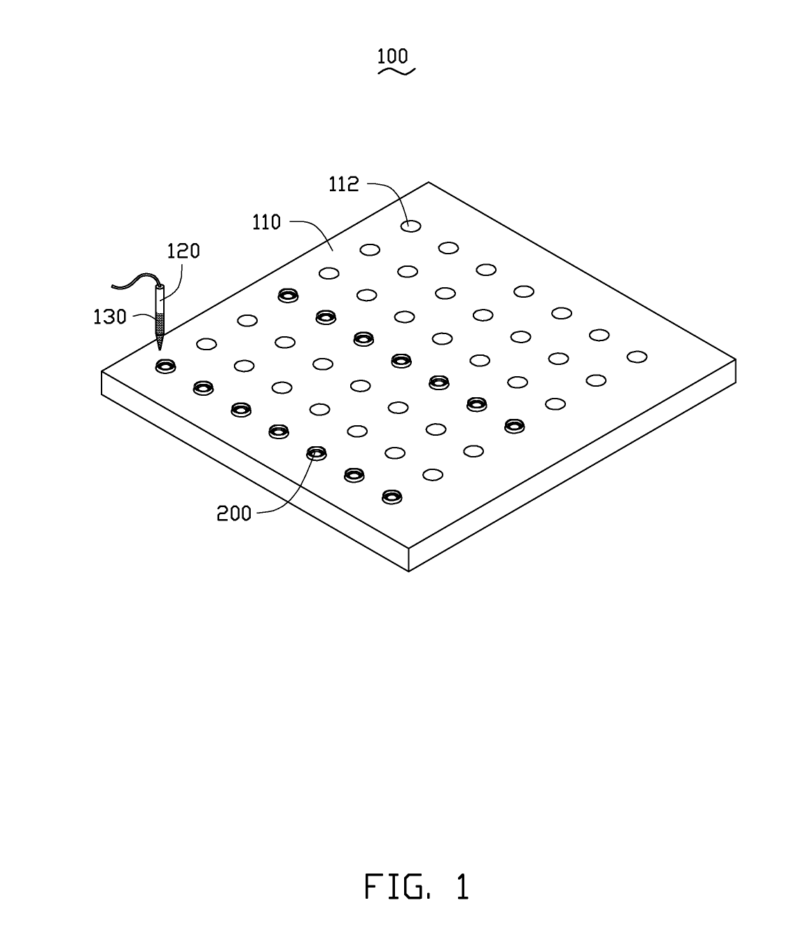

Referring to FIG. 1, a liquid dispenser 100 for use in relation to a lens module 200 in accordance with an embodiment is shown.

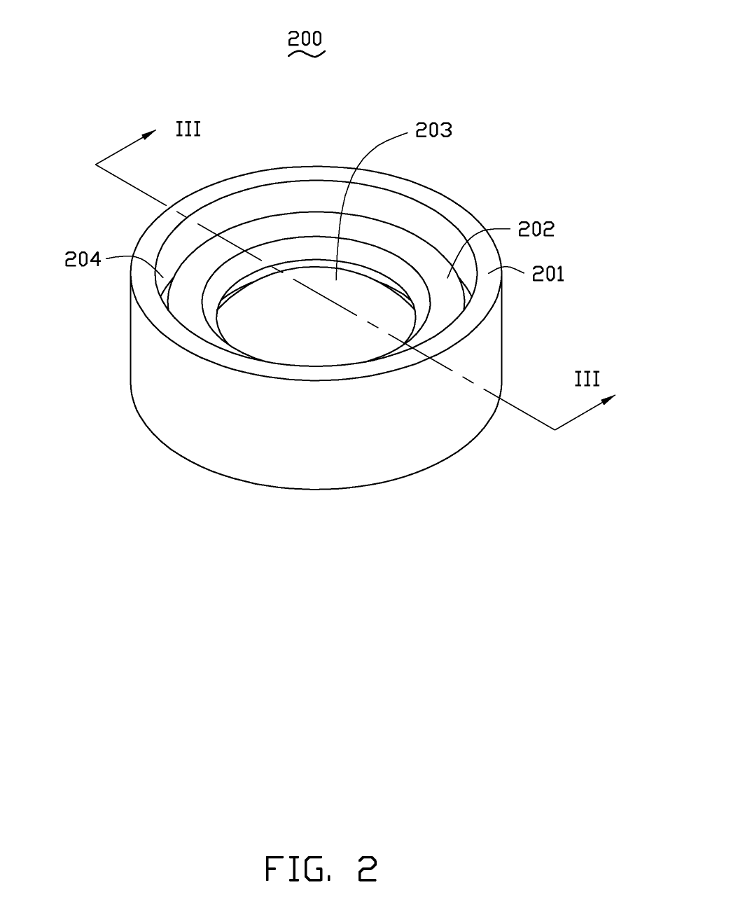

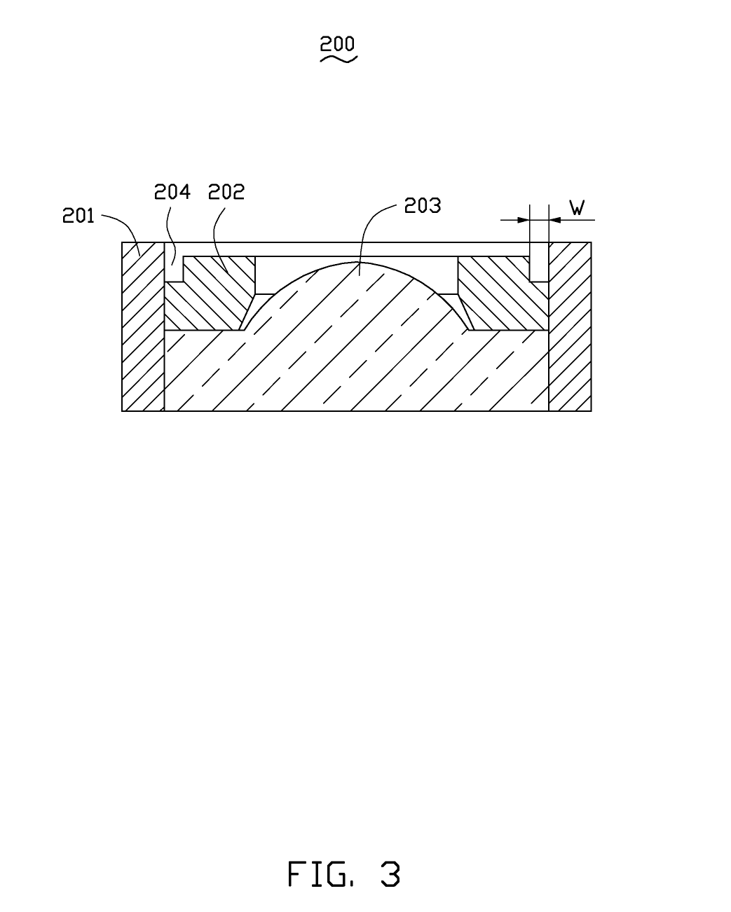

Referring to FIGS. 2 and 3, the lens module 200 includes a lens barrel 201, a lens 203 and a spacer 202. In assembly, the spacer 202 is mounted into the lens barrel 201 last. The spacer 202 needs to be bonded to the lens barrel 201 by glue. After the spacer 202 is fixed in the lens barrel 201, any other components in the lens barrel 201, including the lens 203, may be fixed in place. The spacer 202 defines an annular receiving groove 204. The inner surface of the lens barrel 201 and the receiving groove 204 are configured for receiving glue to bond the spacer 202 to the lens barrel 201. The radial width W of the receiving groove 204 is about 0.1 millimeters (mm) for a lens module 200 having a diameter of about 4 mm to about 7 mm.

Referring back to FIG. 1, the liquid dispenser 100 includes a needle 120 and a magnetic support base 110.

The inner diameter of the needle 120 is about 0.15 mm. The needle 120 is used for releasing magnetic glue 130 into the receiving groove 204. The magnetic glue 130 is manufactured by adding magnetic particles into normal glue. In this embodiment, the magnetic particles are magnetic metal. The magnetic glue 130 is also an ultraviolet glue. In another embodiment, the magnetic glue 130 can also be a hot-curable glue. The needle 120 disperses glue by an automatic glue dispersing machine or manually.

The magnetic support base 110 defines a number of holes 112 each for receiving a lens module 200.

A dispensing method for using the liquid dispenser 100 includes the steps described below:

First, the lens modules 200 are put in the holes 112 of the magnetic support base 110. The lens modules 200 are in contact with the inner walls of the holes 112.

Second, the magnetic glue 130 is dispensed into the receiving groove 204 of the spacer 202 by the needle 120. The magnetic support base 110 attracts the magnetic glue 130 by magnetic force and makes the magnetic glue 130 flow towards the inner surface of the lens barrel 201. In this way, even if the needle 120 is bigger than the receiving groove 204, the magnetic glue 130 will be attracted away from the optical portion of the lens 203.

Finally, the magnetic glue 130 is solidified by an ultraviolet light, or heat-cured, as the case may be. The solidified magnetic glue 130 fixes the spacer 202 to the lens barrel 201.

It will be understood that the above particular embodiments are shown and described by way of illustration only. The principles and the features of the present disclosure may be employed in various and numerous embodiments thereof without departing from the scope of the disclosure. The above-described embodiments illustrate the scope of the disclosure but do not restrict the scope of the disclosure.

1. A liquid dispenser for dispensing magnetic glue on a lens module, the lens module comprises a lens barrel and a component received in the lens barrel, the liquid dispenser comprising:
a magnetic support base defining at least one hole for receiving the lens module; and
a needle for containing the magnetic glue, wherein the needle is configured for dispersing the magnetic glue on the component, the magnetic support base is configured for attracting the magnetic glue to flow towards an inner surface of the lens barrel by magnetic force.

2. The liquid dispenser of claim 1, wherein the magnetic glue comprises magnetic particles.

3. The liquid dispenser of claim 2, wherein the magnetic glue is an ultraviolet glue.

4. The liquid dispenser of claim 1, wherein the component defines a receiving groove for receiving the magnetic glue.

5. The liquid dispenser of claim 4, wherein the component is an annular spacer, a radial width of the receiving groove is 0.1 millimeters, an inner diameter of the needle is 0.15 millimeters.

6. A dispensing method comprising steps of:
providing a magnetic support base defining at least one hole;
positioning a lens module in one of the at least one hole, the lens module comprising a lens barrel and a component received in the lens barrel;
providing a needle containing a magnetic glue;
dispensing the magnetic glue on the component by using the needle such that the magnetic glue flows towards an inner surface of the lens barrel by a magnetic force between the magnetic support base and the magnetic glue; and
solidifying the magnetic glue to fix the component to the lens barrel.

7. The dispensing method of claim 6, wherein the magnetic glue is solidified by an ultraviolet light.
